(19) United States
(12) Patent Application Publication
(10) Pub. No.: US 2005/0270357 A1
(43) Pub. Date: Dec. 8, 2005

(54) Preparation method of inkjet recording paper

(75) Inventor: Hirokazu Kawai, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/144,010

(22) Filed: Jun. 3, 2005

(30) Foreign Application Priority Data
Jun. 3, 2004 (JP) 2004-165765

(51) Int. Cl. B41J 2/01

(52) U.S. Cl. 347/105

(57) ABSTRACT

A preparation method for an inkjet recording paper obtained by cutting an inkjet recording sheet which has been formed in advance with an image wherein cutting is carried out by: providing a surface of the inkjet recording sheet before cutting with a cut location mark; detecting the cut location mark using a reading sensor; and cutting the inkjet recording sheet.

### CROSS-REFERENCE TO RELATED APPLICATION

This application claims priority under 35 USC 119 from Japanese Patent Application No. 2004-165765, the disclosure of which is incorporated by reference herein.

### BACKGROUND OF THE INVENTION

1. Field of the Invention

The current invention relates to a preparation method for an inkjet recording paper, and in particular to a preparation method of an inkjet recording paper with recording paper with marks that are the basis for sheet cutting.

2. Description of the Related Art

With inkjet recording papers which have an image formed in advance it is necessary when preparing recording paper by cutting down to form the sheet size that there is alignment with the printed image position. When such sheets are mass produced, misalignment within each of the sheets can occur.

For example, with inkjet recording paper for photographic applications, in particular when the user uses an inkjet printer for printing multiple photographs, because the inkjet printer uses standard paper sizes for printing, even if the above misalignment is large, usually printing is automatically carried out such that there is equivalent spacing from the edges of the paper. Because of this, within the paper a variation in the distance between the already formed print and the paper cut position (paper edge) can occur, and misalignment of the photograph position and the pre-printed image position can occur.

In order to try to correct for this a mechanism which detects and adjusts the cutting according to the print position of each sheet becomes necessary.

However, usual methods employed are: when a wide roll-like base paper is un-wound and cut up into sheets of the required size, a long roll web of the base paper is un-wound from the roll, and after slitting in the conveying direction, it is then cut in the width direction; or wide sheets are cut off and then the sheets are cut down to the required size using such as a guillotine (see Japanese Patent Application Laid-Open (JP-A) No. 55-151453).

However, when narrow strip-like webs cut along the conveying direction are cut to the required width direction length, it is difficult to regulate the cutting position of the prescribed length of cut relative to the print, and control the cut position of the print. In particular control of the variation in this cut position is difficult.

### SUMMARY OF THE INVENTION

An aspect of the invention provides a preparation method for an inkjet recording paper by cutting an inkjet recording sheet which has been formed in advance with an image wherein cutting is carried out by: providing before cutting on the inkjet recording sheet cut location marks; detecting the cut location marks using a reading sensor; and cutting the inkjet recording sheet.

### BRIEF DESCRIPTION OF THE DRAWINGS

FIG. 1 is a schematic diagram of an inkjet recording sheet after finishing printing of the cut location marks used in the invention.

FIG. 2 is a schematic diagram of inkjet recording sheet after finishing printing of the cut location marks.

FIG. 3 is a schematic diagram of one unit of a unit type multi-color printing gravure rotary printing machine according to an embodiment of the invention.

FIG. 4 is a schematic diagram of a processing system (unwinding, slitting, cutting, stacking devices) according to the invention.

FIG. 5 is a schematic diagram of a slitting-cutting device according to the invention.

### DETAILED DESCRIPTION OF THE INVENTION

The preparation method for an inkjet recording paper according to the invention is characterized in that an inkjet recording sheet on which an image has been formed in advance is provided with cut location marks; the cut location marks are detected using a reading sensor; and the inkjet recording sheet is cut.

By providing on an inkjet recording sheet, on which an image has been formed in advance, cut location marks, and detecting the cut location mark using the reading sensor, and cutting the sheets, the position of the print and the recording paper cut location can be consistently fixed. As a result of this, inkjet recording sheets can be prepared which are assured to have no misalignment between the print and the outer edges of the final configured sheets (recording paper).

The preparation method for an inkjet recording paper according to the invention will now be explained with reference to the drawings, but the invention is not limited thereby.

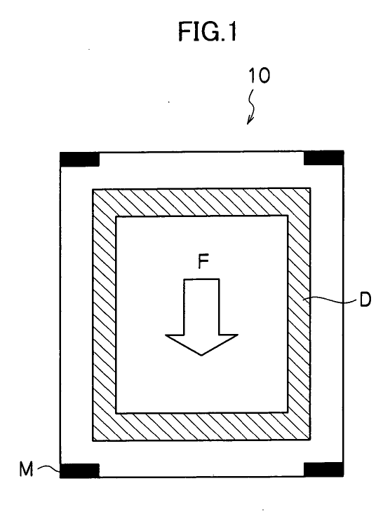

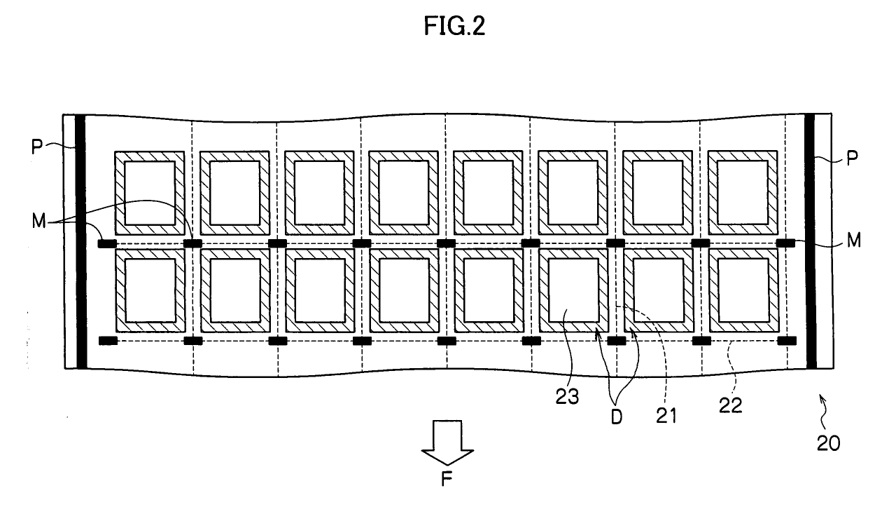

The preparation method for an inkjet recording paper according to the invention is provided by cutting an inkjet recording sheet on which an image and cutting mark have been formed in advance. The inkjet recording sheet is shown in FIGS. 1 and 2. FIG. 1 is a schematic diagram of an inkjet recording sheet after finishing printing of the cut location marks used in the invention. FIG. 2 is a schematic diagram of an inkjet recording sheet (8 rows) after finishing printing of the cut location marks.

As is shown in FIG. 1, the inkjet recording sheet 10 with the cut location marks printed has printed the cut location marks M, for recognition of the image D and the printing position in the conveying direction F.

Also, as is shown in FIG. 2, a inkjet recording sheet 20 (8 rows) with the cut location marks printed also, in the same way as inkjet recording sheet 10, has printed images D and cut location marks M, and is in addition provided with linear marks P for recognition of the printing position in the width direction. That is, it is preferable to provide a part of the surface of the inkjet recording sheet which is to be cut off at the cutting step with a linear mark parallel to conveying direction. Providing the linear mark makes it possible to detect a position perpendicular to conveying direction using the reading sensor based on the linear mark, and to control the position of the inkjet recording sheet.

Here, by “image” is not meant just graphical images, but rather it indicates recorded image information in general which can be recording on a recording medium and is visually recognizable, including text information. As image(s) examples are decoration for images to be printed later, or items for conveying information. Specific examples are character images, patterns/designs, and text/letters.

For character images with characters therein, the characters can be figures which feature in short stories, cartoons, movies, drama, television programs, commercials and the like. Patterns/designs can be patterns or designs.

Also, as text there are lines of characters formed from the arrangement of characters (one or more character), annotations of the images printed, various information such as seasonal and event related, or information applicable to and relating to the purpose of the printed object.

The cut location marks M shown on FIG. 1 are provided in different positions to that of the printed image, however the cut location marks M can be provided within the printed images. Provision in either of these positions is possible, and there is no particular preference.

Regarding the number of cut location marks printed, there is no particular. preference, and 1 mark for several sheets can be provided, or several marks per sheet. From the visual appearance, the same number of marks as the number of sheets is preferable.

Regarding the size of the cut location marks, as long as they are of a size that can be recognized by a cut location mark sensor, explained below, then there is no particular restriction, and it can be arbitrarily determined.

Regarding the shape of the cut location marks, as long as they are of a shape that can be recognized by the cut location mark sensor, explained below, then there is no particular restriction.

As long as the cut location marks are a line drawing of a hue that can be recognized by the cut location mark sensor, then they are not particularly limited, and they can be any type of line drawing.

For ease of explanation the image D in FIG. 1 is shown with a diagonally lined frame, but there is no particular restriction, and it can be of any shape. Also, again for ease of explanation, the size of the image D is as shown in the diagonally lined frame, but it can be of any size. For example, the sheet can be printed such that the whole of the image covers the entire sheet.

In the invention the cut location marks M and the image D can be formed by any type of printing, and inkjet recording or laser recording are possible. From the perspectives of the quality, cost, and reproducibility, it is preferable that one or more selected from the following is used: planographic printing such as off-set printing, intaglio printing such as gravure, relief printing such as rotary letterpress or porous plate such as screen printing. Among these, offset printing (for example sheet offset printing), gravure printing (for example direct gravure printing), and rotary letterpress are more preferable, and direct gravure printing and rotary letterpress are particularly preferable.

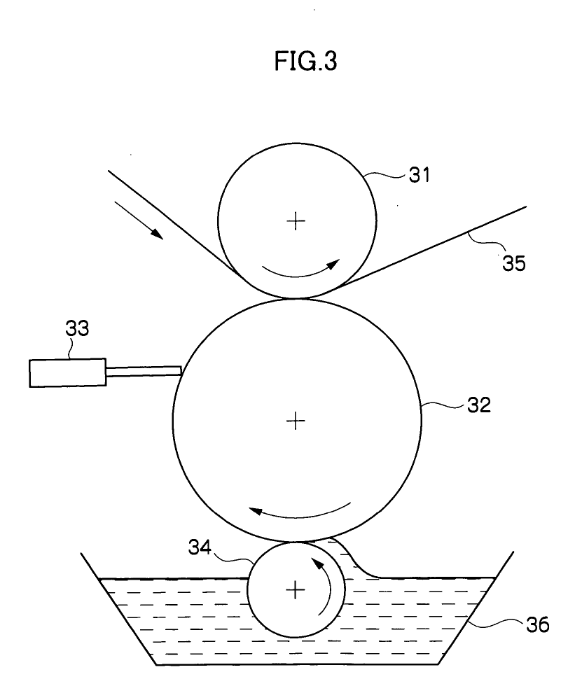

In FIG. 3 shows a schematic diagram of one unit of a 2 to 10 color printing unit type multi-color printing rotary gravure printing machine in an embodiment of the invention in which printing of cut location marks and image D is carried out. In FIG. 3 is shown: 31, an impression cylinder; 32, a printing roll; 34, a furnisher roll; 33, a doctor blade; 36, an ink tray; 35, a print receiving body (inkjet recording sheet). This is a construction that can produce the inkjet recording sheet of FIG. 2, by placing a plate with four facets around the circumference of a 592 mm printing cylinder and 8 facets in the width direction. The linear mark P is preferably provided on the part of the surface of the inkjet recording sheet which is to be cut off at the cutting step, but the position is not limited therein. The width of the linear mark is not limited as long as it can be detected by the sensor.

A specific explanation will be given below of an example where, according to the invention, the inkjet recording sheet cut location marks M and image D can be formed at the same time, however the invention is not restricted to this example. It is suitable to print the cut location marks M and the image D on separate occasions, but forming both at the same time is preferable from the perspective of productivity.

The inkjet recording sheet is printed by: first mounting a printing plate with the image (not illustrated) onto a unit type multi-color rotary gravure printing machine; using solvent based ink and a printing speed of 80 to 150 m/min, preferably 100 to 130 m/min; and with printing conditions of a drying temperature of 40 to 140° C., preferably 60 to 100° C. In this manner an inkjet recording sheet can be obtained on which on the ink receiving layer thereon is formed by printing with the cut location marks M and the image D.

The printing conditions can be suitably selected according to the application and purpose. Also, there is no particular restriction on the ink used for printing. Whilst solvent based inks can be used, from the perspective of the stability of print quality, use of inks for gravure printing machines is preferable, and particularly preferable is inorganic pigmented inks. Any know inorganic pigmented inks can be used.

By carrying out printing of the inkjet recording sheet in such a manner, inkjet recording sheets which have images of good tone, and quality can be reliably produced in high volumes and at low cost.

Now the slitting-cutting of the inkjet recording sheet in order to prepare the inkjet recording paper according to the invention will be described. However, the invention is not limited by this example.

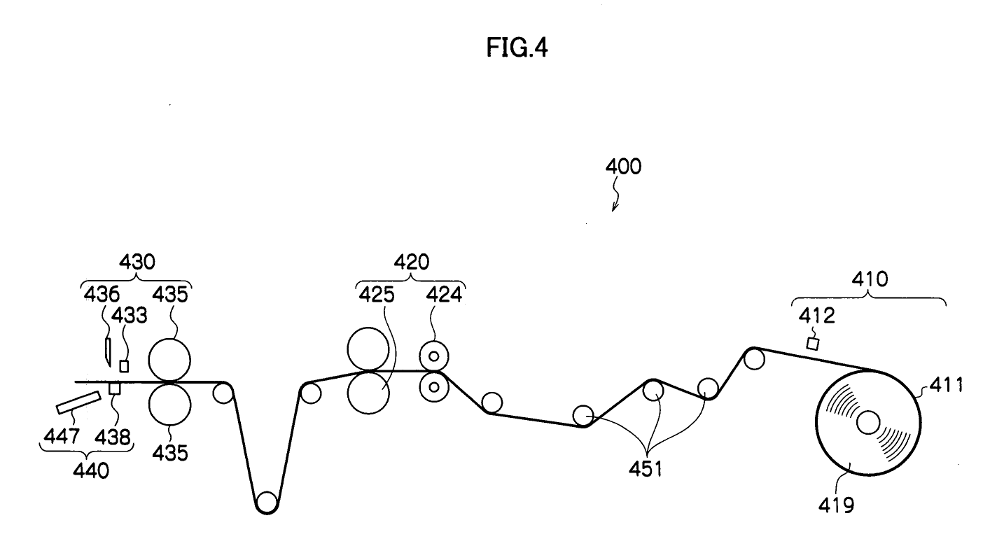

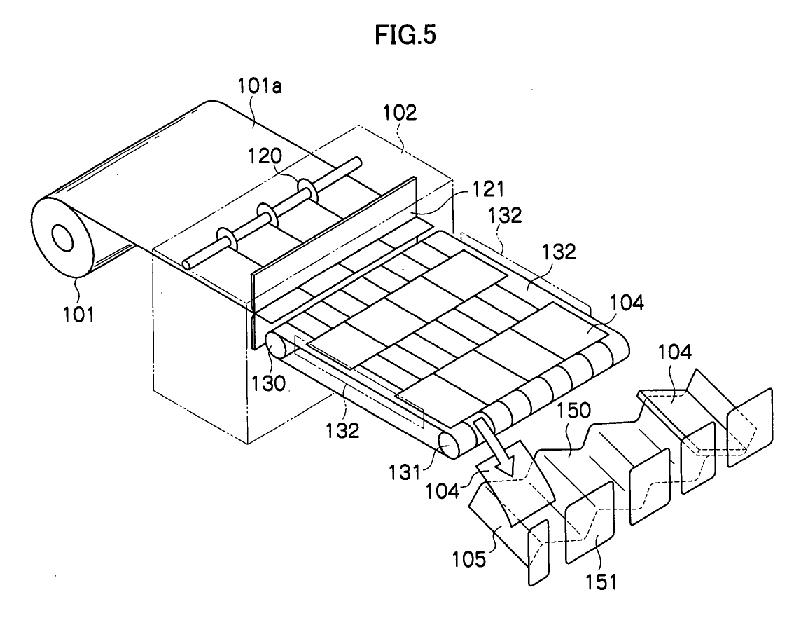

The slitting-cutting and stacking of the inkjet recording sheet will be described below with reference to FIGS. 4 and 5.

—Inkjet Recording Sheet Slitting-Cutting Process—

FIG. 4 is a schematic diagram of an example of a sheet slitting-cutting apparatus of a processing system (unwinding, slitting, cutting, stacking devices) according to the invention. The sheet processing system manufactures inkjet recording paper uses as sheet material inkjet recording sheets that become various sizes of inkjet recording paper, such as L size, and postcard size. This is done by loading in a wound roll form of the sheet, and by unwinding the inkjet recording sheet as the source material and processing to the required size of sheet. Hence, the inkjet recording paper can be manufactured.

In the sheet processing system 400 an unwinding device 410, a slitting device 420, a cutting device 430 and a stacking device 440 are interconnected.

—Unwinding—

In FIG. 4 the unwinding device 410 has at least: a source material chuck mechanism 419, for loading in a source material 411; and a line control sensor 412, for detecting the printing position in the width direction. The loaded source material 411 is unwound from the outside periphery and conveyed to the slitting device 420.

Between the unwinding device 410 and the slitting device 420 are disposed multiple path rolls 451, and the inkjet recording sheet 411 unwound from the source material chuck mechanism 419 is wrapped around the path rolls 451 in sequence.

The unwinding device 410 is provided with the line control sensor 412. The position of the source material being controlled so that the print line on the inkjet recording sheet 411 (a linear mark P in FIG. 2), detected by the line control sensor 412, passes at a certain position in the width direction (axial line direction), and slitter knives 424 of slitting device 420, described later, are able to slit the inkjet recording sheet 411 at certain positions in the width direction. By so doing, the inkjet recording sheet 411 can be slit in the conveying direction in alignment with the applied print.

The detection using a line sensor is preferable to carry out continuously for a period of time. The continuous detection means a repeating of the detection for a given period of time. Shortening the interval of the detection time is preferable to increase the detection accuracy. Lengthening the detection time is also preferable to increase the detection accuracy.

—Slitting—

The slitting device 420 is provided such that one or more pair of slitter knives 424 can be disposed at predetermined positions on the inkjet recording sheet 411 in the width direction, and driven by a drive so that they rotate.

The slitter knives 424 are such that, whilst gripping the inkjet recording sheet 411, they can be rotationally driven and form 2 or more slit openings slitting at a predetermined width.

Also, the slitting device 420 has feed rollers 425 disposed downstream of the slitter knives 424 and which are rotationally driven by the driving force of a drive, and whilst gripping the inkjet recording sheet 411 convey it towards the cutting device 430 in such a way that it does not overlap with itself.

—Cutting—

The cutting device 430 is provided with a pair of feed rollers 435 and a mark sensor 433 for detecting cut location marks M. The mark sensor 433 is a general purpose photoelectric sensor (e.g. models E3Z, manufactured by OMRON, or model PZ2, manufactured by KEYENCE) or a color mark sensor which is able to discriminate between the colors of the paper/marks (e.g. models E3MV, or E3MC manufactured by OMRON, or model CZ manufactured by KEYENCE).

In the cutting device 430 the inkjet recording sheet 411 fed in from the slitter is gripped by the feed rollers 435, and conveyed towards the cutter knife and bottom knife. At the same time in the cutting device 430 the cutting timing of the inkjet recording sheet 411 is recognized and a cutter knife 436 is operated to undertake cutting. The 411 is conveyed by a prescribed amount and, with the detection of each cutting mark by the mark sensor 433, the inkjet recording sheet 411 conveying is stopped, and the inkjet recording sheet 411 is cut in the width direction by the operation of the cutter knife 436.

In other words, the operation of the cutter knife is such that the inkjet recording sheet 411 is conveyed a certain distance with a timing so as to match the print between the cutter knife and bottom knife and by the cutting of the inkjet recording sheet 411 it is possible to prepare inkjet recording paper. The inkjet recording paper is stored in the stacking device described below.

—Stacking—

The stacking device 440 is provided downstream of the cutting device 430, and is provided with a stacking tray (not shown) in which to accommodate in a stack of the inkjet recording sheets 411. This stacking tray is provided with storage units which are formed in the minor widths in accordance with the number of inkjet recording papers. In this way, the inkjet recording papers cut by the operation of the cutter knife are let down into the storage units of the stacking tray, and accommodated by stacking.

There is no particular restriction to the methods which can be used in detecting the cutting marks according to the invention, and any known method can be used. For example, regarding the cutting mark detection device see the detection methods as in the publications such as the Japanese Patent Application Laid-Open (JP-A) No. 58-149199. Regarding the stacking device, devices such as sheet stacker devices as described in the publications such as Japanese Patent Application Laid-Open (JP-A) No. 55-151453 can be used.

The inkjet recording paper according to the invention can be prepared from any recording sheet for inkjet use, but it is preferable to prepare it from the inkjet recording sheets described below. Among these, a photographic printing high gloss inkjet recording paper is most preferable.

Details of the inkjet recording sheet, layer configuration (ink receiving layer, substrate, and the like), structural components and the preparation thereof according to the invention will be described.

—Ink Receiving Layer (Coating Liquid)—

The ink receiving layer of the inkjet recording medium according to the invention preferably includes solid fine particles as the main component. Here, the main component means the structural component that is included to the greatest extent in the composition of the ink receiving layer. And the ink receiving layer of the inkjet recording medium according to the invention preferably includes a water-soluble resin as a resin binder.

(Solid Fine Particles)

The solid fine particles can be organic or inorganic particles, but from the perspective of reproducibility of the printed areas of image, inorganic particles are preferable.

A porous structure of the ink receiving layer of the inkjet recording medium can be obtained, by the inclusion of the solid fine particles, and by this the ink absorption ability can be raised. In particular, inclusion of solid fine particles to a level of 50% or more by mass, and more preferably 60% or more by mass, relative to the total solid contents in the ink receiving layer, is preferable since then it is possible to improve further the porous structure, and provide an inkjet recording medium with sufficient ink absorption ability. Here, the amount included of solid fine particles relative to the total solid contents of the ink receiving layer means the included amount calculated based on the compositions of the structure of the ink receiving layer excluding water components.

For the above inorganic fine particles the following can be used: silica fine particles, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminium silicate, calcium silicate, magnesium silicate, zirconium oxide, zirconium hydroxide, cerium oxide, lanthanum oxide, yttrium oxide, and the like. Among these, from the viewpoint of forming a porous stucture, silica fine particles, colloidal silica, alumina fine particles or hydrates thereof, or pseudo-boehmite, are preferable, and silica fine particles are particularly preferable.

Silica fine particles have the merit of having extremely high specific surface areas, and provide higher ink absorption and retention capacity, and in addition a low refractive index. Thus, if dispersed at a suitable particle diameter, they provide the ink receiving layer with better transparency, and higher color density and favorable coloring of printed images is obtainable. And silica fine particles also have the merit to provide the ink receiving layer with glossiness. The transparency of ink receiving layer is important from the viewpoint of obtaining a high color density and favorable coloring glossiness, not only for applications where transparency is required such as OHP sheets and the like, but also for applications such as photographic glossy papers and like recording sheets.

The average primary particle diameter of the silica fine particles is preferably 20 nm or less, more preferably 15 nm or less, particularly preferably 10 nm or less. If the average primary particle diameter is 20 nm or less then the effect of the ink absorption characteristics can be raised, and at the same time the glossiness of the ink receiving layer surface can be increased.

In particular, if the silica fine particles have silanol groups on the surface, then through hydrogen bonds of the silanol groups the fine particles can easily adhere to each other. Also, through the adherence together of fine particles, due to silanol groups and water soluble resin, if as above the primary particle diameter is 20 nm or less then the void ratio of the ink receiving layer is large, and a structure with high transparency can be formed, thereby raising the ink absorption ability.

Silica fine particles are commonly classified roughly into wet method particles and dry method (vapor phase process) particles according to the method of manufacture. In the above wet method, silica fine particles are mainly produced by generating an activated silica by acid decomposition of a silicate, appropriately polymerizing the activated silica, and aggregation precipitation of the resulting polymeric silica to give hydrated silica. Alternatively, in the gas phase process, silica (anhydrous silica) particles are mainly produced by either high-temperature gas-phase hydrolysis of a silicon halide (flame hydrolysis process), or by reductively heating and vaporizing quartz and coke in an electric furnace, by applying an arc discharge and then oxidizing the vaporized silica with air (arc method). The “vapor-phase process silica” means anhydrous silica fine particles produced by the gas phase process. Vapor-phase process silica fine particles are especially preferable as the silica fine particles according to the invention.

The vapor-phase process silicas are different in the density of silanol groups on the surface and the presence of voids therein and exhibit different properties from hydrated silicas. The vapor-phase process silicas are suitable for forming three-dimensional structures which are higher in void percent. The reason for this is not clearly understood but it can be supposed that hydrated silica fine particles have a high density of silanol groups on the surface, at 5 to 8 per nm², thus the silica fine particles tend to coagulate densely. However, vapor-phase-process silica particles have a lower density of silanol groups on the surface, at 2 to 3 per nm², therefore, vapor-phase process silica seems to cause less compact, softer coagulations (flocculations), consequently leading to structures with a higher void percentage.

Also, the silica fine particles can be used together with the other fine particles described above. When the other fine particles are combined with vapour-phase silica then the included amount of the vapour-phase silica relative to the total amount of fine particles is preferably 30% or more by mass, and more preferably 50% or more by mass.

In the invention for solid fine particles alumina fine particles, alumina hydrate, and mixtures or complexes thereof are also preferable examples. Among them, alumina hydrate is preferable, as it absorbs and holds inks well. Pseudo-boemite (Al_{2O}₃.nH₂O) is particularly preferable. Alumina hydrate may be used in a variety of forms. Alumina hydrate is preferably prepared by using boehmite in the sol state as the starting material, as it provides smoother layers more easily.

The average pore radius of pseudo-boemite is preferably 1 to 30 nm and more preferably 2 to 15 nm. The pore volume thereof is preferably 0.3 to 2.0 cc/g, and more preferably 0.5 to 1.5 cc/g. The average pore radius and the pore volume are determined by the nitrogen absorption/desorption method. These values may be determined, for example, by using a gas absorption/desorption analyzer (e.g., trade name: Omnisorp 369, manufactured by Beckman Coulter, Inc.).

Among alumina fine particles, gas phase alumina fine particles are preferable due to their large surface area. The average primary particle diameter of gas phase alumina is preferably 30 nm or less, more preferably 20 nm or less.

—Water-Soluble Resin—

For the water-soluble resin examples include: polyvinyl alcohol resins having a hydroxy group as the hydrophilic constitutional unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinylacetal, etc.]; cellulosic resins [methylcellulose (MC), ethylcellulose (EC), hydroxyethylcellulose (HEC), carboxymethylcellulose (CMC), hydroxyethylmethylcellulose, hydroxypropylmethylcellulose, etc.]; chitins; chitosans; starches; ether bond-containing resins [polyethylene oxide (PEO), polypropylene oxide (PPO), polyethylene glycol (PEG), polyvinyl ether (PVE), etc.]; carbamoyl group-containing resins [polyacrylamide (PAAM), polyvinylpyrrolidone (PVP), polyacrylic acid hydrazide, etc.]; and the like.

In addition, resins having a carboxyl group as a dissociative group, such as polyacrylate salts, maleic acid resins, and alginate salts; gelatins, and the like, can also be used.

Amongst these polyvinyl alcohol resins are preferable.

Regarding the quantity of the water soluble resin above used, in order to avoid the inclusion of too little, resulting in a decrease in the membrane strength and cracks when drying, and at the same time avoid the inclusion of too much, resulting in pores becoming easily blocked by the resin and the void ratio decreasing, the content of the water soluble resin of the invention is preferably 9 to 40% by mass, more preferably 12 to 33% by mass, relative to the mass of total solids of the ink receiving layer.

The water soluble resin and fine particles mainly constituting the ink receiving layer of the invention may comprise respective single materials, or a mixed material of a plurality of materials.

For the above “polyvinyl alcohols” included in addition to polyvinyl alcohol is cationic modified PVA, anionic modified PVA, silanol modified PVA, and derivatives of other polyvinyl alcohols included therein. Polyvinyl alcohols can be used singly or in combinations of two or more.

(Membrane Curing Agent (Cross Linking Agent))

In the inkjet recording medium of the invention the ink receiving layer, the coated layer (porous layer) containing solid fine particles and water soluble resin, can also be a porous layer which is cured by a membrane curing agent that obtains cross-linking of the water soluble resin.

For the above cross-linking of the water soluble resin a boron compound is preferably. Examples of boron compounds include borax, boric acid, borate salts [e.g., orthoborate salts, InBO_{3,} ScBO₃, YBO₃, LaBO₃, Mg₃(BO₃)₂, and Co₃(BO₃) ₂], diborate salts [e.g., Mg₂B₂O₅, and Co₂B₂O₅], metaborate salts [e.g., LiBO₂, Ca(BO₂)₂)₂, NaBO₂, and KBO₂], tetraborate salts [e.g., Na₂B₄O₇.10H₂O], pentaborate salts [e.g., KB₅O₈.4H₂O, and CsB₅O₅], Ca₂B₆O₁₁.7H₂O, and the like. Among them, borax, boric acid and borates are preferable since they are able to promptly cause a cross-linking reaction

Compounds, as described below, other than the boron compounds can be used for the membrane curing agent of the water-soluble resin. Examples of such cross-linking agents include: aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine and 2,4-dichloro-6-S-triazine sodium salt; active vinyl compounds such as divinyl sulfonic acid, 1,3-divinylsulfonyl-2-propanol, N,N′-ethylenebis (vinylsulfonylacetamide) and 1,3,5-triacryloyl-hexahydro-S-triazine; N-methylol compounds such as dimethylolurea and methylol dimethylhydantoin; melamine resin such as methylolmelamine and alkylated methylolmelamine; epoxy resins; isocyanate compounds such as 1,6-hexamethylenediisocyanate; aziridine compounds such as those described in U.S. Pat. Nos. 3,017,280 and 2,983,611; carboxyimide compounds such as those described in U.S. Pat. No. 3,100,704; epoxy compounds such as glycerol triglycidyl ether; ethyleneimino compounds such as 1,6-hexamethylene-N,N′-bisethylene urea; halogenated carboxyaldehyde compounds such as mucochloric acid and mucophenoxychloric acid; dioxane compounds such as 2,3-dihydroxydioxane; metal-containing compounds such as titanium lactate, aluminum sulfate, chromium alum, potassium alum, zirconyl acetate and chromium acetate; polyamine compounds such as tetraethylene pentamine; hydrazide compounds such as adipic acid hydrazide; and low molecular compounds or polymers containing at least two oxazoline groups.

These cross-linking agents may be used alone, or in combinations of two or more thereof.

The amount of membrane curing agent used is preferably 1 to 50% by mass relative to the water soluble resin, and more preferably 5 to 40%.

(Dispersant)

For the inkjet recording medium according to the invention, in order to achieve good dispersal of the solid particles in the ink receiving layer coating liquid it is possible to add a dispersant. A dispersant, by having a function as a mordant, it is possible to ensure an improvement in the water resistance and resistance to bleeding which develops with time of formed images.

For such a dispersant, as organic dispersants cationic polymers (cationic dispersants) are preferable. By the presence of such a dispersant in the ink layer the ink can be stabilized by the interaction thereof with anionic dyes in liquid inks used as ink, giving an improvement in the water resistance and resistance to bleeding which develops with time. Organic dispersants can be used singly or in combinations with organic dispersants and/or inorganic dispersants.

As the above cationic dispersants, polymer dispersants with primary, secondary or tertiary amino groups or quaternary ammonium salt groups can be generally used. Alternatively, in the invention, cationic non-polymer dispersants can also be used.

The polymer dispersant is preferably obtained as: a homopolymer of a monomer (mordant monomer) having primary to tertiary amino groups or salts thereof, or quaternary ammonium salt groups; or a copolymer or condensed polymer of the mordant monomer and other monomers (hereinafter referred to as “non-mordant monomer”). These polymer dispersants can be used in the form of water-soluble polymer or water dispersible latex particles.

Examples of the monomer (mordant monomer) include trimethyl-p-vinylbenzyl ammonium chloride, trimethyl-m-vinylbenzyl ammonium chloride, triethyl-p-vinylbenzyl ammonium chloride, triethyl-m-vinylbenzyl ammonium chloride, N,N-dimethyl-N-ethyl-N-p-vinylbenzyl ammonium chloride, N,N-diethyl-N-methyl-N-p-vinylbenzyl ammonium chloride, N,N-dimethyl-N-n-propyl-N-p-vinylbenzyl ammonium chloride, N,N-dimethyl-N-n-octyl-N-p-vinylbenzyl ammonium chloride, N,N-dimethyl-N-benzyl-N-p-vinylbenzyl ammonium chloride, N,N-diethyl-N-benzyl-N-p-vinylbenzyl ammonium chloride, N,N-dimethyl-N-(4-methyl)benzyl-N-p-vinylbenzyl ammonium chloride, and N,N-dimethyl-N-phenyl-N-p-vinylbenzyl ammonium chloride; trimethyl-p-vinylbenzyl ammonium bromide, trimethyl-m-vinylbenzyl ammonium bromide, trimethyl-p-vinylbenzyl ammonium sulfonate, trimethyl-m-vinylbenzyl ammonium sulfonate, trimethyl-p-vinylbenzyl ammonium acetate, trimethyl-m-vinylbenzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, and N,N-diethyl-N-methyl-N-2-(4-vinylphenyl)ethyl ammonium acetate; and compounds of valency 4 such as methyl chlorides, ethyl chlorides, methyl bromides, ethyl bromides, methyl iodides or ethyl iodides of N,N-dimethylaminoethyl(meth)acrylate, N,N-diethylaminoethyl(meth)acrylate, N,N-dimethylaminopropyl(meth)acrylate, N,N-diethylaminopropyl(meth)acrylamide, N,N-dimethylaminoethyl(meth)acrylamide, N,N-diethylaminoethyl(meth)acrylamide, N,N-dimethylaminopropyl(meth)acrylamide and N,N-diethylaminopropyl(meth)acrylamide or anion substituted sulfonate salts, alkyl sulphonate salts, acetate salts or alkyl carboxylic acid salts thereof.

Specifically, the following can be used: monomethyldiallylammonium chloride, trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride; N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Also, as co-polymerizable monomers N-vinylimidazole, and N-vinyl-2-methylimidazole can be used.

The non-mordant monomers refer to those that contain no basic portions such as primary to tertiary amino groups or quaternary ammonium salts, or cationic portions and that do not interact, or exhibit substantially small interaction, with dyes in an ink-jet ink.

For the above non-mordant monomers examples of monomers which can be used are: alkylester(meth)acrylates; cycloalkylester(meth)acrylates such as cyclohexyl(meth)acrylate; arylester(meth)acrylates such as phenyl(meth)acrylate; aralkylesters such as benzyl(meth)acrylate; aromatic vinyls such as styrene, vinyltoluene, and α-methylstyrene; vinyl esters such as vinyl acetate, vinyl propionate, vinyl versatic acid; allyl esters such as allyl acetate; halogen containing monomers such as vinylidene chloride, and vinyl chloride; cyanogenated vinyls such as (meth)acrylonitrile; olefins such as ethylene, and propylene.

Of the above alkyl(meth)acrylates it is preferable that the it is an alkyl(meth)acrylate with an alkyl portion which has 1-18 carbon atoms such as methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, hexyl(meth)acrylate, octyl(meth)acrylate, 2-ethylhexyl(meth)acrylate, lauryl(meth)acrylate and stearyl(meth)acrylate.

Among these, methyl acrylate, ethyl acrylate, methyl(meth)acrylate, ethyl(meth)acrylate, and hydroxyethyl(meth)acrylate are preferable.

The above non-mordant monomers can be used singly or in combinations of two or more.

Furthermore, as the polymer dispersant preferable examples are: polydiallyldimethylammonium chloride, polymethacryloyloxyethyl-β-hydroxyethydimethylammonium chloride, polyethyleneimine, polyallylamine or denatured products thereof, polyallylamine chlorate, polyamide-polyamine resin, cationized starch, dicyandiamide formalin condensate, dimethyl-2-hydroxypropylarnmonium salt polymer, polyamidine, polyvinylamine or acryl silicon latex cationized acryl emulsions such as those listed in Japanese Patent Applications Laid-Open (JP-A) Nos. 10-264511, 2000-43409, 2000-343811, and 2002-120452 (Daicel Chemical Industries products: Aqua bleed series ASi-781, ASi-784, ASi-903). Polyallylamine and polyallylamin denatured products are particularly preferable.

The above polyallylamine denatured products are polyallylamine to which between 2 to 50 mol % of acrylnitrile, chloromethylethylene, TEMPO, epoxyhexane, or sorbic acid has been added. From the perspective of obtaining resistance against fading due to ozone, preferably acrylnitrile, chloromethylethylene, or TEMPO is added at a quantitiy of 5 to 10 mol %, and more preferably still TEMPO is added at 5 to 10% to polyallylamine.

Regarding the molecular weight of the above dispersant, the mass average molecular weight is preferably 2,000 to 300,000. If the molecular weight is within this range then the water resistance and resistance to bleeding which develops with time can be even further enhanced.

From the perspective of dispersion of solid fine particles, the organic dispersant according to the invention is preferably a acrylic cationic polymer or a derivative thereof.

For the inkjet recording medium of the invention, it is also possible to use an inorganic mordant as well as the organic dispersant. Examples of possible inorganic mordants are multi-valent water soluble metal salts and hydrophobic metal salt compounds.

Specific examples of inorganic mordants include salts and complexes of metals such as magnesium, aluminium, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth.

More specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, cupric ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminium sulfate, aluminium alum, basic polyhydroxy aluminum, aluminum sulfite, aluminum thiosulfate, polychlorinated aluminum, aluminium nitrate nonahydrate, aluminium chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconium acetate, zirconium sulfate, zirconium ammonium carbonate, zirconyl stearate, zirconyl octylate, zirconyl nitrate, zirconium oxychloride, zirconium hydroxychloride, chromium acetate, chromium sulfate, magnesium sulfate, magnesium chloride hexahydrate, magnesium citrate nanohydrate, sodium phosphotungstate, sodium tungsten citrate, 12-tungstophosphate n-hydrate, 12-tungustosilisic acid 26 hydrate, molybdenum chloride, 12-molybdophosphate n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride and bismuth nitrate.

In the inkjet recording medium of the invention the inorganic mordant is preferably a compound containing aluminum, a compound containing titanium, a compound containing zirconium, and/or a metallic compound (or a salt thereof) of a IIIb series element.

The amount of the above mordants contained in the ink receiving layer of the invention is preferably 0.01 g/m² to 5 g/m², and more preferably 0.1 g/m² to 3 g/m².

(Other Components)

In the inkjet recording medium of the invention other known additives can be further added as required, such as, for example, UV absorbing agents, anti-oxidants, anti-fading agents, optical brightening agents, monomers, polymerization initiating agents, polymerization inhibitors, anti-bleeding agents, preservatives, viscosity stabilizers, anti-foaming agents, surfactants, anti-static agents, matting agents, anti-curl agents, and water proofing agents.

Examples of ultraviolet absorbers include cinnamic acid derivatives, benzophenone derivatives and benzotriazolyl phenol derivatives. Specific examples include α-cyano-phenyl cinnamic acid butyl, o-benzotriazole phenol, o-benzotriazole-p-chlorophenol, o-benzotriazole-2,4-di-t-butyl phenol, o-benzotriazole-2,4-di-t-octyl phenol. A hindered phenol compound can also be used as an ultraviolet absorber, and specifically phenols in which at least one or more of the second place and/or the sixth place is substituted by a branched alkyl group are preferable.

Also a benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers are described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572 and 48-54965, 50-10726, U.S. Pat. Nos. 2,719,086, 3,707,375, 3,754,919 and 4,220,711 or the like.

An optical brightening agent can be also used as an ultraviolet absorber, and specific examples include a coumalin based brightening agent. Specific examples are described in JP-B Nos. 45-4699 and 54-5324 or the like.

Examples of the antioxidants are described in EP 223739, 309401, 309402, 310551, 310552 and 459416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685, 4-291684, 5-61166, 5-119449, 5-188687, 5-188686, 5-110490, 5-1108437 and 5-170361, JP-B Nos. 48-43295 and 48-33212, U.S. Pat. Nos. 4,814,262 and 4,980,275.

Specific examples of the antioxidants include 6-ethoxy-1-phenyl-2,2,4-trimethy-1,2-dihydroquinoline, 6-ethoxy-1-octyl-2,2,4-trimethyl-1,2-dihydroquinoline, 6-ethoxy-1-phenyl-2,2,4-trimethy-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methy-4-methoxy-diphenylamine, 1-methyl-2-phenyl indole.

Anti-fading agents can be used singly or in combinations of two or more. Anti-fading agents can be dissolved, dispersed, or encapsulated in microcapsules. Regarding the amount added of the anti-fading agent, this is preferably 0.01 to 10% by mass of the ink receiving layer coating liquid.

In the ink receiving layer of the invention in order to suppress curl it is preferable to include an organic solvent with a high boiling point. For this organic solvent with a high boiling point one that is water soluble is preferably. For this organic solvent with a high boiling point alcohols such as such as ethyleneglycol, propyleneglycol, diethyleneglycol, triethyleneglycol, glycerin, diethyleneglycol monobutylether (DEGMBE), triethyleneglycol monobutylether, glycerin monomethylether, 1,2,3-butanetriol, 1,2,4-butanetriol, 1,2,4-pentanetriol, 1,2,6-hexanetriol, thiodiglycol, triethanolamine, polyethyleneglycol (mass average molecular weight below 400) can be used. Diethyleneglycol monobutylether (DEGMBE) is preferable.

The amount of the above high boiling point solvents in the ink receiving layer coating liquid is preferably 0.05 to 1% by mass, and particularly preferable is 0.1 to 0.6% by mass.

Also, in order to increase the dispersability of the inorganic pigment particles, a wide variety of inorganic salts, and for adjusting the pH, acids and alkalis can be included.

Furthermore, in order to suppress the occurrence on the surface of friction static electricity and triboelectric effects, electron-conducting metal oxide fine particles can be added, and in order to reduce the frictional characteristics on the surface, matting agents can be added.

It is preferable to include a surfactant in the ink receiving layer coating liquid (referred to later as coating liquid A) in the inkjet recording medium of the invention. For the surfactant cationic, anionic, non-ionic, amphoteric, fluorine type, and silicon type surfactants can all be used.

Examples of preferable nonionic surfactant include polyoxyalkylene alkylether and polyoxyalkylene alkylphenylether (such as diethyleneglycol monoethylether, diethyleneglycol diethylether, polyoxyethylene laurylether, polyoxyethylene stearylether and polyoxyethylene nonylphenylether); oxyethylene-oxypropylene block copolymer, sorbitan fatty acid esters (such as sorbitan monolaurate, sorbitan monooleate and sorbitan trioleate); polyoxyethylene sorbitan fatty acid esters (such as polyoxyethylene sorbitan monolaurate, polyoxyethylene sorbitan monoolelate and polyoxyethylene sorbitan trioleate); polyoxyethylene sorbitol fatty acid esters (such as tetra oleic acid polyoxyethylene sorbit); glycerin fatty acid esters (such as glycerol monooleate); polyoxyethylene glycerin fatty acid esters (such as monostearic acid polyoxyethylene glycerin and monooleic acid polyoxyethylene glycerin); polyoxyethylene fatty acid esters (such as polyethyleneglycol monolaurate, and polyethyleneglycol monooleate); polyoxyethylene alkylamine; and acetylene glycols (such as 2,4,9,7-tetramethyl-5-decyn-4,7-diol, and ethylene oxide adducts and propylene oxide adducts of the diol). Polyoxyalkylene alkyl ethers are preferable among them. A nonionic surfactant may be used in both coating liquid A and coating liquid B. The nonionic surfactants may be used alone, or as combinations of two or more.

Examples of the amphoteric surfactants include those of amino acid type, carboxyamonium betaine type, sulfoammonium betaine type, ammonium sulfonic ester betaine type and imidazolium betaine type, and those described in USP No. 3,843,368, JP-A Nos. 59-49535, 63-236546, 5-303205, 8-262742 and 10-282619 may be favorably used. Amphoteric surfactants of the amino acid type are preferable as the amphoteric surfactant, which are derived from amino acids (such as glycine, glutamic acid and histidine) as described in JP-A No. 5-303205. An example thereof is N-aminoacyl acid in which a long chain acyl group is introduced and the salt thereof. The amphoteric surfactants may be used alone, or as combinations of two or more.

Examples of the anionic surfactants include fatty acid salts (for example sodium stearate and potassium oleate), salts of alkylsulfuric acid ester (for example sodium lauryl sulfate and triethanolamine lauryl sulfate), sulfonic acid slats (for example sodium dodecylbenzene sulfonate), alkylsulfosuccinic acid salts (for example sodium dioctylsulfosuccinate), alkyldiphenylether disulfonic acid salts, and alkylphosphoric acid salts.

Examples of the cationic surfactants include alkylamine salts, quaternary ammonium salts, pyridinium salts and imidazolium salts.

Examples of the fluorine containing surfactants include a compound derived via an intermediate having perfluoroalkyl groups using any one of electrolytic fluorination, teromerization and origomerization methods.

Examples of the fluorine containing surfactants include perfluoroalkyl sulfonic acid salts, perfluoroalkyl carboxylic acid salts, perfluoroalkyl ethylene oxide adducts, perfluoroalkyl trialkyl ammonium salts, perfluoroalkyl group containing oligomers, and perfluoroalkyl phosphoric acid esters.

Silicon surfactants are preferably a silicone oil modified with an organic group, which may have a structure comprising side chains of a siloxane structure modified with the organic group, a structure having modified both terminals, and a structure having a single modified terminal. Examples of modification with the organic group include amino modification, polyether modification, epoxy modification, carboxyl modification, carbinol modification, alkyl modification, aralkyl modification, phenol modification and fluorine modification.

In the inkjet recording medium of the invention the amount contained of the surfactant of the invention is preferably 0.001 to 2.0%, more preferably 0.01 to 1.0%, relative to the coating liquid (coating liquid A) for the ink receiving layer. When two or more coating liquids for the ink receiving layer are used for coating, it is preferable to add surfactant to each respective coating liquid.

<Substrate>

Either transparent substrates made of transparent materials such as plastics, or opaque substrates made of opaque materials such as paper sheets may be used as the substrate of the invention. A transparent substrate or highly glossy opaque substrate is preferably used in order to take advantage of transparency of the ink receiving layer.

The materials used for the transparent substrate are preferably transparent and resistant to radiant heat generated when used in an OHP and back-light display. The preferable materials thereof include polyesters such as polyethylene terephthalate; polysulfone, polyphenylene oxide, polyimide, polycarbonate and polyarnide. Polyesters are preferable, and polyethylene terephthalate is particularly preferable among them.

While the thickness of the substrate is not particularly restricted, it is preferably 50 to 200 μm from the viewpoint of ease of use.

An opaque substrate having high glossiness preferably has a glossiness of 40% or more in the surface where the ink receiving layer is deposited. The glossiness is measured according to a 75 degree specular gloss test method of paper sheets and paper board (JIS P-8142). Specific examples of the substrate are as follows.

They are, for example, highly glossy paper substrates such as art paper, coated paper, cast-coat paper, and barite paper used for silver salt photographic substrate; high gloss films made to be opaque by adding a white pigment and the like in plastic films such as polyesters such as polyethylene terephthalate (PET), cellulose esters such as nitrocellulose, cellulose acetate and cellulose acetate butylate, polysulfone, polyphenylene oxide, polyimide, polycarbonate and polyamide (a calender treatment may be applied to the surface); and substrates having high gloss film coated layers of polyolefin either containing or not white pigment on the surface of various paper substrates.

Foamed polyester films containing white pigment (for example foamed PET that contains polyolefin fine particles, and in which voids are formed by stretching) are also favorably used. Resin coated paper used for the silver salt photographic printing paper is also favorably used.

While the thickness of the opaque substrate is not particularly restricted, it is preferably 50 to 300 μm considering ease of use.

A corona discharge treatment, glow discharge treatment, flame treatment or UV irradiation treatment may be applied to the surface of the substrate for improving wetting and adhesive properties.

The base paper sheet used for resin coat paper will be described in detail below.

The base paper is produced using wood pulp as a major material, and by adding a synthetic pulp such as polypropylene pulp, or synthetic fibers such as nylon or polyester fibers, into the wood pulp, as required. While any one of LBKP, LBSP, NBKP, NBSP, LDP, NDP, LUKP and NUKP may be used as the wood pulp, LBKP, NBSP, LBSP, NDP and LDP pulps, which are abundant in short fibers, are preferably used.

However, the proportion of LBSP and/or LDP is preferably 10% to 70% by mass.

Chemical pulps (sulfate pulp and sulfite pulp) containing few impurities are preferably used, and pulp having improved brightness, by applying a bleaching treatment, is also useful.

To the base paper sheet the following may be appropriately added: sizing agents such as a higher fatty acid or alkylketene dimer; white pigments such as calcium carbonate, talc and titanium oxide; paper strength enhancers such as starch, polyacrylamide and polyvinyl alcohol; optical brighteners; moisture retention agents such as polyethyleneglycol; dispersing agents; and softening agents such as quaternary ammonium.

The freeness of the pulp used for paper making is preferably 200 to 500 ml as defined using the CSF. The fiber length after beating is defined as a value measured by a sieve classification method according to JIS P-8207, and the sum of the percentage by mass of the 24 mesh filtration residue and the percentage by mass of the 42 mesh filtration residue is preferably 30 to 70% by mass. The percentage by mass of the 4 mesh filtration residue is preferably 20% by mass or less.

The average basis weight of the base paper sheet is preferably 30 to 250 g/m², and particularly preferably 50 to 200 g/m². The thickness of the base paper is preferably 40 to 250 μm. The base paper sheet may be highly smootherd by applying a calender treatment during the paper making process, of after the paper making process. The density of the base paper is usually 0.7 to 1.2 g/m² (JIS P-8118).

The rigidity of the base paper is preferably 20 to 200 g under the conditions according to JIS P-8143.

A surface sizing agent may be applied onto the surface of the base paper sheet, and the same sizing agent as added in the base paper sheet described above may be used as the surface sizing agent.

The pH of the base paper sheet is preferably 5 to 9 as measured by a hot water extraction method according to JIS P-8113.

Polyethylene used for coating the surface face and back face of the base paper sheet is mainly low density polyethylene (LDPE) and/or high density polyethylene (HDPE), but LLDPE, polypropylene and the like may be used in part.

Titanium oxide of rutile or anatase type, fluorescent whitener and ultramarine blue are preferably added into the polyethylene layer that forms the ink receiving layer to improve opaqueness, whiteness, and hue, as widely adopted in photographic printing paper sheets. The content of titanium oxide is preferably 3 to 20% by mass, more preferably 4 to 13% by mass, relative to polyethylene. While the thickness of the polyethylene layer is not particularly restricted, a thickness of 10 to 50 μm is favorable for both the top and back surface layers. An undercoat layer may be provided on the polyethylene layer for endowing the polyethylene layer with an adhesive property to the ink receiving layer. Aqueous polyester, gelatin and PVA are preferably used as the undercoat layer. The thickness of the undercoat layer is preferably 0.01 to 5 μm.

A polyethylene coated paper sheet may be used as glossy paper, or when polyethylene is coated on the base paper sheet by melt-extrusion a matte surface or silk finish surface may be formed by applying an embossing treatment, as obtainable in usual photographic printing paper sheets.

A back coat layer may be provided on the substrate, and examples of the components which can be added to the back coat layer include white pigments, aqueous binders and the like.

Examples of the white pigment contained in the back coat layer include inorganic white pigments such as calcium carbonate light, calcium carbonate heavy, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene plastic pigments, acrylic plastic pigments, polyethylene, microcapsules, urea resin and melamine resin.

Examples of the aqueous binders used for the back coat layer include water soluble polymers such as styrene/maleic acid copolymer, styrene/acrylate copolymer, polyvinyl alcohol, silanol modified polyvinyl alcohol, starch, cationic starch, casein, gelatin, carboxymethyl cellulose, hydroxyethyl cellulose and polyvinyl pyrrolidone; and water dispersible polymers such as styrene-butadiene latex and acrylic emulsion.

Other components contained in the back coat layer include defoaming agents, foaming suppressing agents, dyes, optical brighteners, preservatives and water-proofing agents.

<Inkjet Recording Sheet (Medium) Production>

The inkjet recording sheet according to the invention has an ink receiving layer provided on at least one surface of a substrate.

The substrate provided with an ink receiving layer on at least one of the surfaces thereof is also sometimes referred to as an inkjet recording medium below.

This will be described in detail below, but the invention is not limited to this example.

In the inkjet recording medium manufacturing method according to the invention first an aqueous medium containing a curing agent and dispersant is prepared.

For the solvents of the aqueous medium water, organic solvents or mixtures thereof can be used. For water distilled water, or ion exchange water are suitable. For the organic solvents which can be used for coating alcohols such as methanol, ethanol, n-propanol, i-propanol and methoxypropanol, ketones such as acetone and methylethyl ketone, and tetrahydrofuran, acetonitrile, ethyl acetate and toluene can be used.

The amount included of a curing agent in the aqueous medium is preferably 0.2 to 2.0% by mass, and particularly preferable is 0.5 to 1.0% by mass. Also, the amount included of a dispersant in the aqueous medium is preferably 3 to 15% by mass relative to the total solid contents, and particularly preferable is 5 to 10% by mass.

It is preferable to dissolve or disperse the curing agent and dispersant in the aqueous medium prior to the addition of the solid fine particles.

Next the solid fine particles are added to the aqueous medium.

Here, it is preferable that the solid fine particles are added whilst stirring the aqueous liquid in a dissolver.

After the addition of the solid fine particles stirring in the dissolver is continued, and the solid fine particle dispersion liquid can be obtained by, if required, further treatment in such as a sand grinder.

To the solid fine particle dispersion liquid, in order to obtain the ink receiving layer coating solution (coating solution A), may be further added and mixed: a water soluble resin aqueous solution, such as a hydroxy propyl cellulose aqueous solution; a surfactant or other selected component.

The coating liquid obtained is a homogeneous sol, and a porous ink receiving layer having a three dimensional network structure is formed by applying the coating liquid onto the substrate by an application method described below, followed by drying.

The ink receiving layer of the inkjet recording medium of the invention cross-linking curing in the coating layer is preferably carried out by the application of a coating liquid B in the following manner. A coating liquid A containing at least fine particles is coated onto the surface of the substrate, and a coating liquid B, having a pH value of 7 or more, is applied onto the coating layer, at either (1) the same time as forming the coating layer by applying coating liquid A; or (2) during the drying of the coating layer formed by applying coating liquid A and also before the coating layer exhibits a decrease in the drying rate.

The coating liquid B (basic liquid) can be prepared, for example, by the following method. That is, to ion exchange water, is added the required mordant (for example at 0.1 to 5.0% by mass) and surfactants (for example to a total content of 0.01 to 1.0% by mass) whilst stirring thoroughly. It is preferable that the pH of liquid B is 7.0 or above, and the pH can be adjusted to above 7.0 using ammonia solution, sodium hydroxide, potassium hydroxide, amino group containing compounds (such as ethyl amine, ethanol amine, diethanol amine and polyallylamine) as appropriate.

It is preferable to add a mordant to the liquid B, since by so doing the mordant will be largely present in a particular region of the ink receiving layer, and so the inkjet ink will be sufficiently mordanted resulting in improvement in the following properties; color density; suppression of occurrence of bleeding with time; glossiness of the printed areas; water resistance of text and images after printing; and resistance to ozone.

The ink receiving layer coating liquid can be applied by a known coating method using an extrusion die coater, air doctor coater, blade coater, rod coater, knife coater, squeeze coater, reverse roll coater and bar coater.

The coating liquid B is applied at substantially the time as the coating with coating liquid A; or the coating liquid B may be applied after applying the coating liquid for the ink receiving layer (coating liquid A) but before the coated layer exhibits a decreasing rate of drying. In other words, the ink receiving layer is favorably produced by applying the coating liquid B after applying the coating liquid for the ink receiving layer (coating liquid A) and while the coated layer exhibits a constant rate of drying. A mordant may be contained in the coating liquid B.

The phrase “before the coated layer exhibits a decreasing rate of drying” as used herein usually means a lapse of time of several minutes from immediately after application of the ink receiving layer coating liquid. The “constant rate drying” phenomenon is the period in which the content of the solvent (dispersion medium) in the applied coated layer is reduced in proportion to the lapse of time. The period exhibiting the “constant rate drying” is described in Kagaku Kogaku Binran (Handbook of Chemical Engineering; pp. 707-712, Maruzen Co., Ltd., Oct. 25, 1980).

The period in which the ink receiving layer is dried until the coated layer exhibits a decreasing rate of drying after applying the coating liquid A is usually 0.5 to 10 minutes (preferably 0.5 to 5 minutes) at 40 to 180° C. Although the drying period is naturally different depending on the amount of coating, the range above is usually appropriate.

Examples of application methods before the first coated layer exhibits a decreasing rate of drying include (1) a method of additionally coating liquid B on the coated layer, (2) a spraying method, and (3) a method for dipping the substrate comprising the coated layer thereon in the coating liquid B.

Methodd available for applying the coating liquid B in the method (1) include methods known in the art such as using a curtain flow coater, extrusion die coater, air doctor coater, blade coater, rod coater, knife coater, squeeze coater, reverse roll coater and bar coater. However, the methods of using a extrusion die coater, curtain flow coater or bar coater are preferable, since these methods are able to apply the coat without making direct contact with the already formed first coated layer.

The coating amount of the coating liquid B is generally 5 to 50 g/m² , and 10 to 30 g/m² is preferably.

After applying the coating liquid B, usually it is heated at 40 to 180° C. for 0.5 to 30 minutes for drying and hardening. Heating at 40 to 150° C. for 1 to 20 minutes is preferable

When the coating liquid B is applied at substantially the same time as applying the coating liquid for the ink receiving layer (coating liquid A), coating liquid A and coating liquid B are simultaneously applied (multi-layer application) on the substrate so that coating liquid A contacts the substrate, followed by hardening by drying to form the ink receiving layer.

Above-described simultaneous application (multi-layer application) can be performed by the coating method using the extrusion die coater, the curtain flow coater, and the like. While the coated layer formed is dried after the simultaneous application, the layer is usually dried by heating at 40 to 150° C. for 0.5 to 10 minutes, preferably at 40 to 100° C. for 0.5 to 5 minutes.

When the coating liquids are applied so as to form a multi-layer with the extrusion die coater, for example, the multi-layer is formed in the vicinity of the discharge port of the extrusion die coater by simultaneously discharging the two kinds of the coating liquids before transferring onto the substrate, in order to directly form the dual coated layer. Before application the two kinds of the coating liquids in the multi-layer tend to form cross-links, at the interface between the two solutions, before being transferred onto the substrate. Hence the two solutions are liable to be thickened by being mixed with each other in the vicinity of the discharge port of the extrusion die coated. This may make the coating operation difficult. Accordingly, it is preferable to simultaneously form a triple layer by making a barrier layer solution (an intermediate layer solution) interpose between the two coating liquids A and B.

The barrier layer solution may be selected without any restrictions including, for example, an aqueous solution containing a trace amount of a water soluble resin and water. The water soluble resin is added as a thickener for improving coating performance. Examples of water soluble resins include cellulose resins (such as hydroxylpropylmethyl cellulose, methyl cellulose and hydroxyethyl cellulose), polyvinyl pyrrolidone and gelatin. A mordant may be added to the barrier layer solution.

The surface smoothness, glossiness, transparency and coated layer strength may be improved by applying calender treatment, heating and passing the sheet through roll nips under pressure, using a super calender or gloss calender machine after forming the ink receiving layer is formed on the substrate. However, since calender treatment may cause a decrease of the void ratio (resulting in a decrease in ink absorbing property), conditions that give a small decrease of the void ratio should be employed.

The roll temperature for applying the calender treatment is preferably 30 to 150° C., more preferably 40 to 100° C.

The linear pressure between the rolls for calender treatment is preferably 50 to 400 kg/cm, more preferably 100 to 200 kg/cm.

Since the ink receiving layer is required to have a thickness that renders an absorption capacity enough for absorbing all the droplets in the ink-jet recording, the thickness should be determined in relation to the void ratio in the layer. For example, the thickness should be about 15 μm or more when the amount of the ink is 8 nl/mm² and the void ratio is 60%.

The thickness of the ink receiving layer is preferably 10 to 50 μm for ink-jet recording considering the conditions above.

The median diameter of the voids in the ink receiving layer is preferably 0.005 to 0.030 μm, more preferably 0.01 to 0.25 μm.

The void ratio and median diameter can be measured using a mercury porosimeter (trade name: Poresizer 9320-PC2, manufactured by Shimadzu Corporation).

While it is preferable that the ink receiving layer is excellent in transparency, the criterion of transparency is that the ink receiving layer formed on a transparent film substrate preferably has a haze value of 30% or less, and more preferably 20% or less.

The haze value is measured using a haze meter (trade name: HGM-2DP, manufactured by Suga Test Instrument Co., Ltd.).

A dispersion of polymer fine particles may be added to the constituting layers of the ink jet recording sheet of the invention (for example the ink receiving layer or back layer). This polymer fine particle dispersion is used for improving film properties such as dimensional stability, curl prevention, adhesion prevention and crack prevention. Suitable polymer fine particle dispersion are described in each of the publications JP-A Nos. 62-245258, 62-1316648 and 62-110066. Cracking and curling of the layer can be prevented by adding a polymer fine particle dispersion having a low glass transition temperature (40° C. or less) in the layer containing the mordant. Curling may be also prevented by adding a polymer fine particle dispersion having a high glass transition temperature to the back layer.

### EXAMPLES

While the present invention is described in detail with reference to examples, the invention is by no means restricted to these examples. “Parts” and “%” in the examples mean “parts by mass” and “% by mass” unless otherwise stated, and “average molecular weight” and “degree of polymerization” represent “weight average molecular weight” and “weight average degree of polymerization”

### Example 1

(Substrate Production)

As wood pulp 100 parts of LBKP is beaten in a double disc refmer to a Canadian Freeness of 300 ml, then epoxidated behenic acid amide of 0.5 parts, anionic polyacrylamide of 1.0 parts, polyamide-polyamine epichlorohydrin of 0.1 parts, cationic polyacrylamide of 0.5 parts are added, all parts being dry weights relative to the pulp. Then a 170 g/m² basis weight paper is manufactured on a Foudrinier machine.

In order to prepare a surface sizing for the above base paper, to a 4% solution of polyvinyl alcohol is added 0.04% of an optical brightening agent (trade name: Whitex BB; manufactured by Sumitomo Chemical Industries Corporation) and this is applied to the surface of the base paper in such a way that it impregnates therein at a rate which equates to a dry coating weight of 0.5 g/m². After drying, the base paper is obtained by further calendering to adjust to a secific density of 1.05.

After undertaking corona electrical discharge treatment of the wire surface (back surface) of the substrate paper, the surface is coated to a thickness of 19 μm with high density polyethylene using an extrusion machine, and a resin layer is formed on what was the matt surface (from now on this thermoplastic resin layer surface will be referred to as the ‘back surface’). Further corona electrical discharge treatment is carried out on the resin layer of this back surface. Then, as an anti-static agent, aluminium oxide (trade name: Aluminasol 100; manufactured by Nissan Chemical Industries Ltd) and silicon dioxide (trade name: Snowtex 0; manufactured by Nissan Chemical Industries Ltd) at a mass ratio of 1:2 is dispersed in water to form a treatment liquid and coated to a dry weight of 0.2 g/m².

In addition, on the felt surface (face surface), the side which has not been provided with a resin layer, after undertaking corona electrical discharge treatment a high gloss thermoplastic resin is formed on the face surface of the substrate paper (from now this high gloss thermoplastic resin layer surface is referred to as the “front surface”) to a thickness of 29 μm at a MFR (melt flow rate) of 3.8 using an extrusion machine with low density polyethylene which has been adjusted by adding anatase titanium dioxide to a quantity of 10%, ultramarine to a trace quantity, and further adjusted with 0.01% of optical brightening agent (relative to polyethylene). This is the substrate used in the Example.

(Preparation of Coloring Material Receiving Layer Coating Liquid)

From the components below, (1) distilled water, (2) curing agent and (3) dispersant are agitated in a dissolver whilst adding (4) silica fme particles. After the addition, using a rotation number of 2,000 rpm for 120 minutes a dispersion is formed, and then using a sand grinder (KD-20) the fme particalization treatment is carried out to obtain a silica fine particle dispersion.

| | |
|---|---|
| (1) Distilled water | 1,800 kg |
| (2) Curing agent (boric acid) | 12 kg |
| (3) Dispersant 40% aqueous solution | 60 kg |
| (Acryl cationic polymer, trade name: | |
| Chemistat 7005; manufactured by Sanyo | |
| Chemical Industries) | |
| (4) Silica fine particles | 300 kg |
| (inorganic fine particles) | |
| (trade name: Reolosil QS-30; | |
| manufactured by Tokuyama Corporation; | |
| average primary diameter 7 nm) | |

After keeping at 30° C. for 24 hours, the below listed (5) water soluble resin solution, (6) surfactant and (7) surfactant where mixed in to the above silica fine particle dispersion to obtain the coloring material receiving layer coating liquid A.

| (5) Water soluble resin solution | |
|---|---|
| distilled water | 800 kg |
| diethyleneglycol monobutylether | 10 kg |
| polyvinylalcohol | 60 kg |
| (trade name: PVA124; manufactured by | |
| Kuraray Company) | |
| hydroxypropyl cellulose | 4 kg |
| (trade name: HPC-SSL; manufactured by | |
| Nippon Soda Company Ltd.) | |

After mixing together they are heated to 95° C. for 180 minutes and then cooled to obtain the water soluble resin solution.

| | |
|---|---|
| (6) Surfactant polyoxyethylene oleyl ether 10% sol. | 30 kg |
| (trade name: Emulgen 109P; manufactured by | |
| Kao Corporation) | |
| (7) Surfactant (fluoro surfactant) 10% solution | 15 kg |
| (trade name: Megafac F-1405; manufactured by | |
| Dai Nippon Ink) | |

(Inkjet Recording Sheet Production)

After corona treating the front surface of the substrate, the above obtained coloring material receiving layer coating liquid A is coated onto the front surface of the substrate using an extrusion coater to a coating of 170 ml/m² (coating process). Then it is dried until the solid content concentration in the coating layer is 18% by placing in a hot air dryer at 40° C. (air speed 5 m/sec). During this time the coating layer exhibits uniform rate drying. Immediately afterwards a basic liquid (pH=9.6) composed of the below listed components is impregnated such that 20 g/m² adheres to the coating layer (liquid application process), and then the coating is further dried at 80° C. for 10 minutes (drying process). In this way a coloring material receiving layer with a dry thickness of 35 μm is formed, and an inkjet recording sheet according to the invention is obtained.

-Components of the basic liquid B-

| | |
|---|---|
| (1) Boric acid (cross-linking agent, 100%) | 6.5 kg |
| (2) Ion exchange water | 723.5 kg |
| (3) Basic mordant 20% solution | 150 kg |
| (trade name: PAA-03; manufactured by Nittobo | |
| Corporation) | |
| (4) Surface pH adjusting agent (ammonium chloride, | 1.0 kg |
| 100%) | |
| (5) Surface pH adjusting agent (p-toluene sulfonate, | 18.0 kg |
| 100%) | |
| (6) Surfactant 2% solution | 100 kg |
| (trade name: Emulgen 109P; manufactured by | |
| Kao Corporation) | |
| (7) Surfactant (fluoro surfactant, 100%) | 2 kg |
| (trade name: Megafac F-1405; manufactured by | |
| Dai Nippon Ink) | |

The above obtained prior to image printing photographic printing high gloss inkjet recording sheet is then printed with images according to the following method.

(Production of the Finished Image Printed Inkjet Recording Sheet)

—Print Plate Manufacture—

A print plate for forming images and cut location marks is manufactured with a 150 line screen, and a maximum cell depth of 28 μm using a Helio Klischograph K-500 electronic engraving machine (manufactured by HELL Gravure Systems Company).

Here, the print plate is a print plate with the image D on 4 facets around the circumference and with 8 facets in the width direction, and a linear mark P. The image print corresponding to images of D is shown with diagonal lines for convenience in FIG. 2 (see FIG. 2). The printing plate corresponds to the inkjet recording sheet as shown in FIG. 2.

—Production of the Inkjet Recording Sheet with Finished Printed Image—

The printing plate (not illustrated) is mounted on the print cylinder (circumference 592 mm) of a multi-color rotary-gravure printing machine (made by Nakajima Seiki Engineering). Using solvent based inks (trade name:PANN Color S Series; manufactured by Toyo Ink Manufacturers), a printing speed of 120 m/min, a drying temperature of 80° C., four color image printing, and a run of 1,000 sheets the inkjet recording sheet of the invention of FIG. 2 (original plate size) is obtained. In FIG. 2 the dividing lines 21 and 22 shown are for dividing for the inkjet recording paper, and the non-printed areas 23 are the areas where printing is possible. M and D are the same as shown in FIG. 1.

In this way the obtained finished printed inkjet recording sheet of the invention (original plate size) can be prepared using a similar machine to that illustrated in FIG. 5 but with 8 rows in the width direction, by slitting in the conveying direction and trimming off to form A6 size sheets (105×148 mm) of inkjet recording paper. In FIG. 5, 101 is the original roll, 102 is the cutter unit, 120 is pairs of top and bottom circular rotary knives, 121 is a pair of top and bottom long cutter knives, 130 and 131 are pulleys, 132 is a belt conveyor, 104 are inkjet recording papers, 105 is a stacker for inkjet recording papers, 150 is a receiving plate for inkjet recording papers and 151 is a stopper plate for inkjet recording papers.

[Evaluation]

For 100 sheets of the inkjet recording papers with finished print (A6 size) the gap between the printed area and the edge of the paper in the conveying direction and the width direction was determined and the variation of this was examined. The results of the evaluation according to the below listed criteria is shown in Table 1.

—Evaluation Criteria—

G1: Variation is ±1.0 mm or below

G2: Variation is over ±1.0 mm up to ±1.5 mm, the limits of practically usable level

G3: Variation is over ±1.5 mm, and not practically usable

### Example 2

An inkjet recording paper is prepared in the same way as for Example 1 except in that a printing plate which forms no linear mark parallel to the conveying direction was used and detecting the width direction was carried out based on the cut location mark. The evaluation was also carried out in the same way as in Example 1. The results of the evaluation is shown in Table 1.

### Comparative Example 1

An inkjet recording paper was manufactured in exactly the same way as for Example 1 except in that a print plate which forms no cut location marks was used, and the inkjet recording sheet was cut at a predetermined pitch. The evaluation was carried out in the same way and the results are also shown in Table 1.

TABLE 1

| | Variation in the | | Variation in the | |
|---|---|---|---|---|
| | Conveying | | Width | |
| | Direction (mm) | Evaluation | Direction (mm) | Evaluation |
| Example 1 | ±0.2 | G1 | ±0.3 | G1 |
| Example 2 | ±0.2 | G1 | ±1.5 | G2 |
| Comparative | ±12.5 | G3 | ±0.3 | G1 |
| Example 1 | | | | |

It is clear from Table 1 that in the Comparative Example the variation in the conveying direction is large. In Example 2, there is a slight variation in the width direction. However, in Example 1, the variations both in the conveying direction and in the width direction are outstandingly good.

1. A preparation method for an inkjet recording paper obtained by cutting an inkjet recording sheet which has been formed in advance with an image wherein cutting is carried out by:
providing a surface of the inkjet recording sheet before cutting with a cut location mark;
detecting the cut location mark using a reading sensor; and
cutting the inkjet recording sheet.

2. The preparation method for an inkjet recording paper according to claim 1 wherein the cut location mark and the image are generated by printing.

3. The preparation method for an inkjet recording paper according to claim 1 wherein the cut location mark and the image are generated by one or more of the inkjet recording methods selected from the group consisting of planographic printing, intaglio printing, relief printing and screen printing.

4. The preparation method for an inkjet recording paper according to claim 1 wherein the cut location mark and the image are provided at the same time.

5. The preparation method for an inkjet recording paper according to claim 1 wherein the inkjet recording paper is a high gloss photographic print inkjet recording paper.

6. The preparation method for an inkjet recording paper according to claim 1 wherein an ink receiving layer of the inkjet recording paper contains an organic solvent with a high boiling point.

7. The preparation method for an inkjet recording paper according to claim 1 wherein the inkjet recording paper contains fine particles of a metal oxide compound which have electron conductivity.

8. The preparation method for an inkjet recording paper according to claim 1 wherein the inkjet recording paper contains a matt agent.

9. The preparation method for an inkjet recording paper according to claim 1 wherein a substrate for the inkjet recording paper is a resin coated paper.

10. The preparation method for an inkjet recording paper according to claim 1 wherein the reading sensor is one or more sensors selected from the group consisting of a photoelectric sensor and a color mark sensor.

11. The preparation method for an inkjet recording paper according to claim 1 wherein the inkjet recording sheet source material is in a roll form.

12. The preparation method for an inkjet recording paper according to claim 1 wherein the inkjet recording sheet is cut along the conveying direction before being cut in the width direction.

13. The preparation method for an inkjet recording paper according to claim 1 wherein:
further providing a part of the surface of the inkjet recording sheet which is to be cut off at the cutting step with a linear mark parallel to conveying direction;
detecting a position perpendicular to conveying direction using a line sensor based on the linear mark; and
controlling the position of the inkjet recording sheet.

14. The preparation method for an inkjet recording paper according to claim 13 wherein the detection using the line sensor is carried out continuously for a period of time.
